(19) United States
(12) Patent Application Publication
(10) Pub. No.: US 2020/0237152 A1
(43) Pub. Date: Jul. 30, 2020

(54) TRANSPORTING AND PRESENTATION DEVICE FOR GRATE INSERTS

(71) Applicant: UPGRATE LLC, Newark, DE (US)

(72) Inventor: Bern Felix HAHN, Oppenheim (DE)

(21) Appl. No.: 16/578,145

(22) Filed: Sep. 20, 2019

(30) Foreign Application Priority Data
Jan. 25, 2019 (DE) 20 2019 100 459.2

(51) Int. Cl. A47J 37/07; A47J 47/00

(52) U.S. Cl. CPC A47J 37/0786; A47J 47/005; A47J 37/0763

(57) ABSTRACT

A transporting and presentation device for grate inserts including a main body, handles and recess grips. The main body includes at least one grate insert mount arranged either directly or in an insert ring. The main body is able to accommodate a grate insert. The main body additionally includes a central depression approximately equal in size to the insertable grate insert.

### BACKGROUND

One or more embodiments of the invention relate to a transporting and presentation device for a grate.

It is usually the case, when use is made of a barbecue, that the cooked food is brought to the table, and served, for example, on a plate. This results in the food cooling down comparatively quickly, since these plates are often not pre-heated and therefore the heat of the food is dissipated directly into, for example, the porcelain of the plate, which accelerates the cooling even more. In addition, this method of transporting and presenting food is a well-known and not particularly original method of presentation. In addition, the food has to be removed from the barbecue grate, and arranged on the presentation plate, in individual pieces.

Furthermore, it is known from the catering sector for example for cast-iron pan-like cookware to be placed directly from an oven or from a stove onto the table at which guests are seated. It is usually the case here that the cast-iron pan is positioned on a device for keeping it warm or is placed on a wooden board. This makes use of the advantage that a person can remove portions of food from this pan, but the rest of the food which remains in the pan is kept warm for a relatively long period of time by the heat stored in the cast-iron pan.

In addition, there are special devices which also provide, in catering, for barbecue-like preparation of food directly at the table, which is advantageous, in particular, for presentation purposes and therefore for the guests' entertainment. The disadvantage here, of course, is that the amount of heat developed at the table is comparatively high and in addition, as is also the case with presentation in a pan, there is a risk of guests being burnt on these items.

As far as the configuration of grates is concerned, it is known for the grate to be made up of different elements. In particular, it has become established practice here for a grate to be provided with inserts which can be inserted into a larger grate with a corresponding mount. This means that the insertable grate insert, which is for example round, rectangular or of some other shape, is inserted into a mount in the main grate and can also be removed again from said grate. The grate insert here usually has peripheral extensions, by means of which the insert is positioned in the mount of the larger grate. As an alternative, it is also possible for a frame to accommodate the grate insert, or for other retaining elements, to be integrated in the main grate.

This has allowed a grate to be functionally extended, since the grate insert thereof can be changed over for other modules. The grate insert allows for a continuous grilling surface or alternative uses. It is thus possible for the mount to have inserted into it, to provide for more widely flexible use, a pizza stone, a grilling-pan insert, a “Dutch oven” or else cast-iron “sear grates” for making classic grill marks on the food.

### BRIEF DESCRIPTION OF THE DRAWINGS

One or more embodiments of the invention will be explained in more detail hereinbelow with reference to drawings,

in which:

FIG. 1 shows a chopping board 13 which can be inserted into the upper side of a cloche;

FIG. 2 shows a cloche 10 for setting down on the device;

FIG. 3 shows an insert ring 7 for setting down on the device, in accordance with an embodiment;

FIG. 4 shows a drip pan 5 for insertion into the depression 16 of the main body 1, in accordance with an embodiment;

FIG. 5 shows the main body 1 of the device with a central depression 16, in accordance with an embodiment;

FIG. 6 shows a narrower design of a cloche 10 for setting down on the main body 1;

FIG. 7 shows an alternative insert ring 7, with a set-down edge 17, on which to set down the cloche 10, in accordance with an embodiment;

FIG. 8 shows a perspective illustration of the main body 1 of the device without an insert ring 7, in accordance with an embodiment; and

FIG. 9 shows an illustration of the underside of the main body 1, designed in the form of a chopping board 13, in accordance with an embodiment.

### DETAILED DESCRIPTION

Against this background of the prior art, it is an object of at least one embodiment of the present invention to create a transporting and presentation device for a grate insert which provides a novel, original way of presenting food, while at the same time allowing the food to be removed quickly from the grate and, in addition, also providing for the food to be kept warm and to continue cooking. At the same time, it should be possible for the food to be transported reliably and presented in an original manner.

This is achieved by a transporting and presentation device for a grate insert according to the features of claim 1.

The rest of the claims concern advantageous configurations of the device.

At least one basic concept according to an embodiment, rather than the food being lifted off the grate and presented on a plate, is for the grate insert itself to be lifted off the grate and to be transported together with the food and presented at the table.

One or more embodiments of the present invention makes use here of the fact that, as explained, there are already grates available on the market which, rather than being entirely in one piece, have a carrying grate which contains at least one smaller, removable grate insert. This makes it more easily possible for said smaller, removable grate insert to be placed in the transporting and presentation device.

The transporting and presentation device here has a main body, which serves to accommodate the grate, and also to transport the same, in that the hot grate insert can be inserted into said main body and, at the same time the main body absorbs the heat of the grate insert, but nevertheless remains transportable. In principle, a variety of materials are suitable for this purpose, wherein, from an esthetic point of view, it is expediently the case that a tray-like main body made of wood is particularly advantageous for presentation purposes.

In order, then, for it to be possible for the grate insert to be accommodated in the main body according to an embodiment of the invention, a depression which accommodates at least the diameter of the grate insert is provided centrally here, it being possible for the grate insert which is to be transported to be set down via, or in, said depression.

For this purpose, provision is made for grate-insert mounts to be arranged in the main body of the device, around the depression adapted to the shape of the grate insert, such that extensions, which can be arranged around the periphery of the grate insert, can engage in said grate-insert mounts to the sides of the central depression. In addition to extensions, it is also possible for a specially designed peripheral region of the grate insert to be present, and therefore the grate-insert mount is designed to accommodate said peripheral region. In this way, the grate insert removed from the grate is reliably accommodated and secured against slipping. It is also the case that the central depression should have its outer edge designed in accordance with the dimensions of the grate insert which is to be accommodated, so that the grate insert is reliably retained in the main body of the device.

An advantageous configuration of an embodiment of the invention has a drip pan, which can be inserted into the central depression of the main body of the device. This drip pan serves primarily to collect fat and meat juice dripping from the food, and the inserted grate insert, and therefore to avoid the situation where the device becomes dirty.

Provision is also made in principle here, as an alternative, for the drip pan likewise to be heated prior to being inserted into the main body, so that a kind of heat-storage unit is, in this way, inserted into the main body beneath the grate insert, which is additionally beneficial to the keeping-warm and continued-cooking function.

In addition, provision can be made for a special heat-storage element, for example in the form of a pizza stone, to be inserted into the drip pan or to be provided as part of the drip pan. This provides additional assistance for the keeping-warm and continued-cooking function.

This element can also be insertable into the central depression beneath the drip pan, so that the food does not make it dirty. Accordingly, provision is additionally made, as an alternative, also for a coating to be arranged in the central depression, beneath the drip pan, in order to safeguard the main body against the effect of the heat from the additional heat-storage element.

A further alternative embodiment of the invention provides for a protrusion with a mount, or else just for a mount, to be arranged in the central depression in the main body, said mount serving to center a holder, for example for specific foods such as roast chicken or the like, which is inserted into the main body. This means that this mount can be useful if anything should be positioned in the depression of the main body as an alternative to the grate insert.

A further expedient embodiment of the invention provides for the grate-insert mounts, which are arranged in the main body and are intended for extensions on the grate insert, to be arranged in an insert ring rather than directly in the main body, said insert ring being arranged in an encircling, step-like depression in the upper side of the main body of the device. This means that the main body has an annular depression on its upper side, which is tailored to an insert ring, which is manufactured for example from stainless steel and, in turn, has corresponding grate mounts at the locations at which the grate which is to be inserted has protrusions.

This additionally ensures that the main body does not become dirty or damaged directly by the heat and the soiling of the inserted grate insert, since the insert ring is manufactured from material which is easy to clean and is heat-resistant. In addition to stainless steel, it would also be conceivable here to use, for example, ceramic material or similar materials which are heat-resistant and easy to clean.

In addition, the insert ring also affords an adapter function in respect of the variable grate insert. It is possible for use to be made, in the same encircling, step-like depression in the upper side of the main body, of different insert rings which have constant outer geometries, but, as far as their inner mount is concerned, fit different grate inserts. It is thus possible for possibly different grate inserts from different manufacturers to be placed in the device or else for the insert rings to be adapted to specific requirements of the various grate inserts.

In the case of a further development of the device according to an embodiment of the invention, provision is likewise made for a bell-like cover in the form of a cloche to be set down on the device above the grate insert, said cloche, which spans the grate insert on the upper side of the device, additionally assisting the keeping-warm and continued-cooking function of the device.

This means that, once a grate insert has been lifted off the barbecue and inserted into the device, the action of setting down the cloche prevents quick cooling down and by virtue of the hot grate insert interacting with the hot food, the space enclosed beneath the cloche is heated up quickly and therefore the food is reliably prevented from cooling down.

In order to safeguard this set-down hood in the form of a cloche against slipping off from the upper side of the device, an annular insertion location is provided, said insertion location either being inserted directly into the upper side of the device, following the circumference of the food, or being arranged around the periphery of the inserted insert ring. The cloche is thus retained in position and safeguarded against unintended displacement.

The cloche can be safeguarded against slipping off from the upper side of the device in this way either by one or more protrusions, which are arranged to project upward from the upper side, or by a channel-like depression in the upper side of the main body of the device or in the insert ring. Provision can additionally be made here for an outflow connection to be arranged between the set-down cloche and the drip pan such that condensation which is deposited on the inner side of the cloche is discharged into the drip pan.

An advantageous embodiment of the invention provides, in addition, for the integration of a chopping board. It is possible here, as an alternative, for the latter to be placed as an upper-side insert into, for example, a depression or retaining means on the cloche. This would provide the option of it being possible for the chopping board to be easily removed and cleaned.

As an alternative, or in addition, it would also be possible for a chopping board to form the underside of the main body of the device itself, and therefore, by virtue of being turned round and set down on the upper side, the tray-like main body of the device can be used with the chopping-board-like underside upward.

An encircling drip channel is advantageously arranged in both of these variants. For example meat juice can be collected in said depression when previously barbecued food is being cut up at the table.

It should be stated here, in principle, that the grate insert can be variable in terms of shape and configuration. The mounts in the main body, or else the mounts in the insert ring in the main body, make it possible for the device to be adapted flexibly to different grate inserts, as far as both the dimensions and the basic shape (rectangular, round or some other shape) thereof are concerned.

Since FIGS. 1 to 5 are exploded drawings of a certain embodiment of the device as a whole, all five figures will be referred to hereinbelow.

FIG. 5 shows the main body 1 of the device with lateral grip cavities 2, so that the device can be carried in the manner of a tray, in accordance with an embodiment. For example wood could be the material used for said main body.

This main body of FIG. 5 is designed with an encircling, step-like depression three on the upper side of the main body 1. This mount serves for the insertion of an insert ring 7, as is illustrated in FIG. 3.

It is additionally possible to see the central depression 16, which is arranged in the middle and serves to accommodate the drip pan 5, as is illustrated by way of example in FIG. 4. It is additionally possible to see here that there is a hollow 6 in the underside of the drip pan 5, said hollow being positioned over a protrusion 4, with a central mount, in the depression 16 of the main body. This means that, in this embodiment, the drip pan 5 has a hollow 6, so that the drip pan can butt in a flat state against the base of the depression 16. As an alternative, it could also be possible here for the drip pan to have a planar underside and simply to be configured in a somewhat shallower state.

The centrally arranged mount 4 in the depression 16 of the main body 1 is suitable for adjusting, and retaining, components which are inserted into said depression 16. It is possible here, for example, for a holder (not illustrated in the drawings) for a roast chicken or the like to be positioned in the depression 16 such that its underside engages in the mount 4 and it therefore cannot be displaced within the depression 16.

A further alternative would be for the depression 16 to be designed in the form of a through-passage and for the drip pan 5 to be placed in this through-passage for example by way of a conical shaping of the lateral walls of the drip pan 5 and/or of the depression 16. It is also possible, as an alternative, to have retaining bodies which retain the drip pan 5 in the open depression 16. These alternatives are not illustrated in the drawings.

The insert ring 7 illustrated in FIG. 3 is illustrated here in FIG. 3 in an embodiment which has a planar upper side and an edge 17 on the underside, which additionally safeguards the insert ring 7 in the depression 16 of the main body 1.

It is possibly additionally the case that there are retaining noses 22 on the underside of the insert ring 7, said noses engaging in corresponding mounts in the depression 3 of the main body 1 such that the position of the insert ring is safeguarded against rotation and the insert ring can only be inserted in this way into the depression 3. However, these are optional technical elements.

The insert ring 7 additionally has grate-insert mounts 9, which serve to accommodate extensions on the grate insert, if said extensions are present on the grate insert.

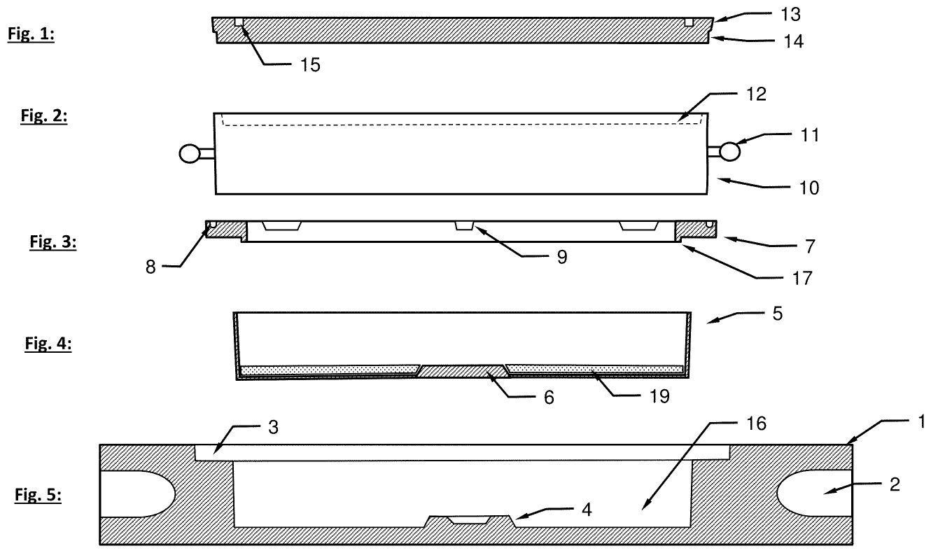

Finally, the embodiment illustrated in FIG. 3 has an annular insert groove 8, which serves to accommodate the lower edge of the cloche 10, which is illustrated in FIG. 2 above the insert ring 7. In at least some embodiments, insert groove 8 is also referred to as a retention depression. The reason for this is that the cloche 10 is thus inserted in a fixed state into said annular insert groove 8 and cannot be displaced in the horizontal plane on the upper side of the main body 1 or of the insert ring 7. It is also possible here for a channel (not illustrated) for draining condensation to be arranged in the drip pan 5, such that condensation which forms on the inner side of the cloche 10 is directed away into the drip pan 5 via said insert groove 8 and a corresponding drainage channel.

The embodiment illustrated, as far as the drip pan 5 and the set-down cloche 10 are concerned, involves an approximately cylindrical body, handles 11 being arranged at the sides of the cloche 10 so that the cloche 10, when heating, can be held reliably.

Finally, the cloche 10, on the upper side, has a chopping-board mount 12, into which can be inserted the chopping board 13 which is illustrated in FIG. 1. In the embodiment illustrated, for this purpose, the chopping board 13 has, on its underside, a step-like tapering 14, by means of which the chopping board 13 can be inserted into the chopping-board mount 12 in the upper side of the cloche 10.

Finally, FIG. 1 also illustrates a drip groove 15 in the chopping board 13, said drip groove serving for drainage or collection of meat juices when the food is being cut up on the chopping board 13.

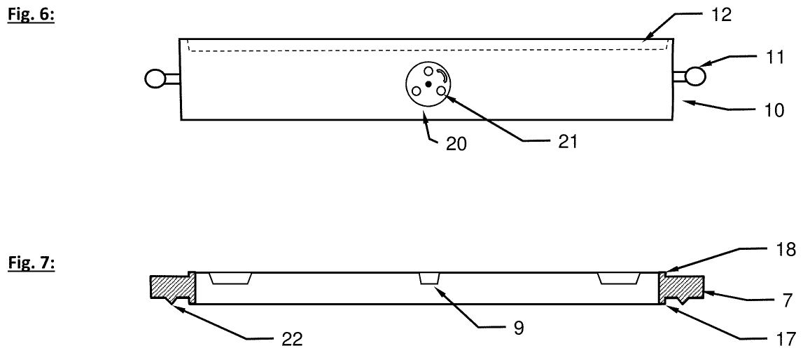

FIGS. 6 and 7 show, together, an alternative embodiment in particular of the insert ring 7. The insert ring here, in addition to the lower edge 17, also has an upper edge 18, which serves to safeguard the cloche 10 when set down. This means that the diameter of the cloche is slightly wider than the diameter of the insert ring 7 in the region of the upper edge 18, and therefore the cloche 10 can be set down on the insert ring 7 in a state in which it is fitted over said upper edge 18. In at least some embodiments, upper edge 18 is also referred to as a retention depression. In a manner analogous to the insert channel 8 described above, it is also the case here that horizontal displacement of the cloche 10 on the insert ring 7 is reliably avoided as a result. Here too, a means for draining condensation into the drip pan 5 can be part of the insert ring 7.

FIG. 6 shows an embodiment of the cloche 10 with a rotatable vent valve 20 that allows to control the conduction of heat and steam from the cloche 10 which effects the condition of the grilled food covered by the cloche. The vent valve 20 shows apertures 21 that by rotating the vent valve 20 can by brought in line with apertures in the cloche 10 to release steam and heat from the interior of the cloche 10. In alternative embodiments the position of the vent valve 20 can be on top of the cloche 10.

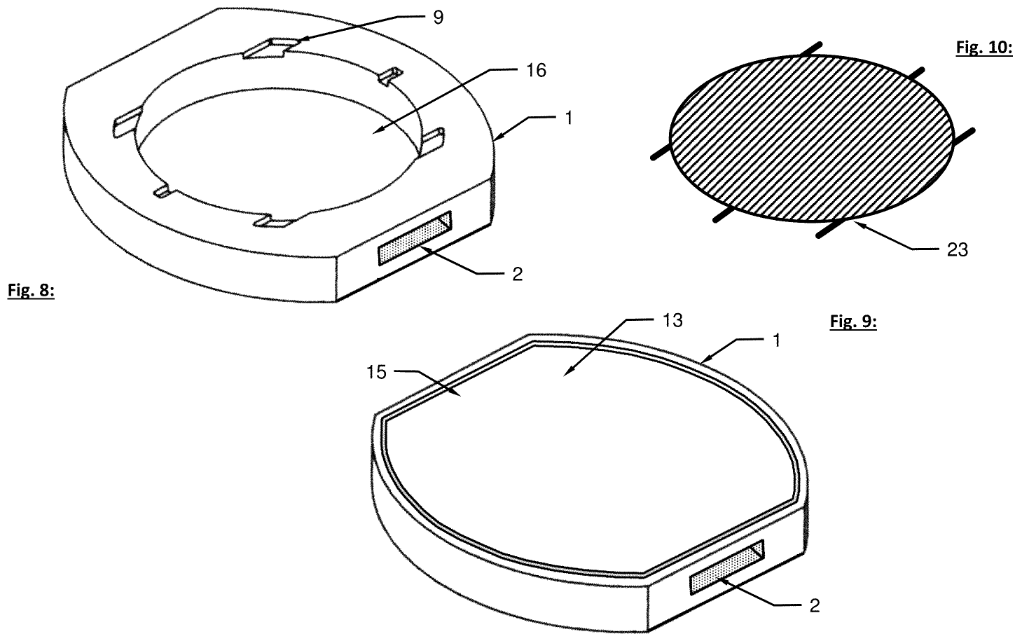

Finally, FIGS. 8 and 9 show two perspective views of the main body 1. FIG. 8 shows a perspective view of the upper side of an embodiment of the main body 1 without an insert ring 7. The aforementioned grate-insert mounts 9 here have been milled directly into the main body 1, for example into a wooden body. These grate-insert mounts 9 here are intended extensions which may be present on the grate insert.

A depression 16 is also arranged in the center here and, as described above, a drip pan 5 can be inserted into it. Additional heat-storage elements (19) which can possibly likewise be inserted into said central depression 16, for example a heat-storage stone body, which has already been pre-heated in the barbecue and can then be inserted into said central depression in order further to assist the keeping-warm and continued-cooking function.

In addition, recessed grips 2 are provided in the sides of the main body 1, so that the device can be carried in the form of a tray.

Finally, FIG. 9 shows the underside of the main body according to FIG. 8. This figure is merely intended to illustrate that the underside of the main body 1 can likewise be designed in the form of a chopping board 13, so that, when not being used for transporting and presentation purposes, the device can have an everyday use. The device can therefore simply be turned over and used on an everyday basis as a chopping board 13. It is advantageously also the case for this purpose that this embodiment has an encircling channel 15 for meat juices and other liquids.

Finally, FIG. 10 shows a possible embodiment of the grate insert 23 by itself to be placed in the grate-insert mounts 9 milled directly into the main body 1 as shown in FIG. 8.

### LIST OF REFERENCE SIGNS

1 Grate tray
2 Lateral recessed grips
3 Encircling, step-like depression
4 Protrusion with mount
5 Drip pan
6 Hollow, on the underside
7 Insert ring
8 Annular insert groove
9 Grate-insert mounts
10 Bell-form cover
11 Handles
12 Chopping-board mount
13 Chopping board
14 Step-like tapering
15 Drip groove, encircling
16 Central depression
17 Lower edge
18 Upper edge
19 Heat-storage unit
20 Vent valve
21 Apertures
22 Retaining noses
23 Grate insert

1. A transporting and presentation device for a grate insert,
the device comprising:
a main body configured to accommodate a grate insert, the main body having
at least one grate-insert mount arranged either directly or in an insert ring,
wherein the main body has a central depression, the central depression being approximately equal in size to the insertable grate insert; and
one or more handles or recessed grips attached to the main body.

2. The transporting and presentation device for a grate insert as claimed in claim 1,
wherein
a drip pan is releasably inserted into the central depression.

3. The transporting and presentation device for a grate insert as claimed in claim 1,
wherein
a protrusion and/or a mount are/is arranged in the center of the central depression.

4. The transporting and presentation device for a grate insert as claimed in claim 3,
wherein
an underside of the drip pan has a hollow for accommodating the protrusion in the central depression.

5. The transporting and presentation device for a grate insert as claimed in claim 2,
wherein
a heat-storage unit is inserted in the drip pan or beneath the drip pan.

6. The transporting and presentation device for a grate insert as claimed in claim 1,
wherein
the insert ring has one or more grate-insert mounts, and the insert ring has a lower edge for engagement in the depression,
wherein a further encircling, step-like depression is formed in the upper side of the main body such that the insert ring into said further depression.

7. The transporting and presentation device for a grate insert as claimed in claim 1,
wherein
the insert ring has an upper edge.

8. The transporting and presentation device for a grate insert as claimed in claim 1,
wherein
a device-covering cloche is configured to be set down on the main body.

9. The transporting and presentation device for a grate insert as claimed in claim 8,
wherein
retention depressions for fixing the cloche on the device in the form of annular insert grooves or upper edges arranged on the main body or the insert ring.

10. The transporting and presentation device for a grate insert as claimed in claim 8,
wherein
an upper side of the cloche has a chopping-board mount, into which a chopping board is insertable.

11. The transporting and presentation device for a grate insert as claimed in claim 10,
wherein
the chopping board has a step-like tapering on an underside, by which the chopping board is insertable into the chopping-board mount of the cloche.

12. The transporting and presentation device for a grate insert as claimed in claim 10,
wherein
the chopping board has an encircling drip groove.

13. The transporting and presentation device for a grate insert as claimed in claim 1,
wherein
the depression is designed in the form of a through-passage of the main body, a drip pan being inserted in a releasable manner into said through-passage.

14. The transporting and presentation device for a grate insert as claimed in claim 1,
wherein
the grate insert is at least one of round, or rectangular,
wherein, in addition to a grill-like grate insert, a special functional insert in the form of at least one of a pizza stone, a grilling-pan insert, a sear grate, a Dutch oven insertable in the device.

15. The transporting and presentation device for a grate insert as claimed in claim 2, wherein
a protrusion and/or a mount are/is arranged in the center of the central depression.

16. The transporting and presentation device for a grate insert as claimed in claim 3, wherein
a heat-storage unit is inserted in the drip pan or beneath the drip pan.

17. The transporting and presentation device for a grate insert as claimed in claim 4, wherein
a heat-storage unit is inserted in the drip pan or beneath the drip pan.

18. The transporting and presentation device for a grate insert as claimed in claim 2, wherein
the insert ring has one or more grate-insert mounts, and the insert ring has a lower edge for engagement in the depression,
wherein a further encircling, step-like depression is formed in the upper side of the main body such that the insert ring fits into said further depression.

19. The transporting and presentation device for a grate insert as claimed in claim 9, wherein
an upper side of the cloche has a chopping-board mount, into which a chopping board is insertable.

20. The transporting and presentation device for a grate insert as claimed in claim 11, wherein
the chopping board has an encircling drip groove.

21. The transporting and presentation device for a grate insert as claimed in claim 9, wherein
the cloche contains a rotatable vent valve that allows to control the conduction of heat and steam from the cloche.
